(19) United States
(12) Patent Application Publication
(10) Pub. No.: US 2014/0185787 A1
(43) Pub. Date: Jul. 3, 2014

(54) EXTENSION TELEPHONE MANAGEMENT SYSTEM, AND OPERATION METHOD FOR EXTENSION TELEPHONE MANAGEMENT SYSTEM, AND PROGRAM THEREOF

(71) Applicant: Dentsu Kogyo Co., Ltd., Tokyo (JP)

(72) Inventor: Nobuo Ariwaka, Tokyo (JP)

(73) Assignee: Dentsu Kogyo Co., Ltd., Tokyo (JP)

(21) Appl. No.: 14/117,745

(22) PCT Filed: Sep. 27, 2012
(86) PCT No.: PCT/JP2012/074916

§ 371 Date: Nov. 14, 2013

(51) Int. Cl. H04M 7/00

(52) U.S. Cl. CPC H04M 7/0093
USPC 379/243

(57) ABSTRACT

The present invention grants IDs to external lines, and is used to manage whether such lines to which such IDs are linked are under suspension or are being operated. Thereby, even if operational statues have been changed, the identities of the relevant lines can be specified, and the changes of various forms of information related to lines accompanying the changes of line numbers described above can be easily tracked and managed. At the same time, telephone sets to which internal numbers are assigned also store the internal and external correspondence information that indicates what external line numbers can be reached by each telephone set to which an extension number is assigned. Thereby, the operational statuses of internal lines accompanying changes of the operational statuses of such external lines can be easily tracked and managed as needed.

### FIELD OF THE INVENTION

The present invention relates to technology that allows efficient management of the operational statuses of extension telephones that are correlated with the operational statuses of telephone lines related to such extension telephones.

### BACKGROND OF THE INVENTION

Conventionally, in relation to commencement of use of telephone lines, subscription contracts have been executed with telephone companies. Such commencement of use has been performed through connecting subscribed lines acquired based on the aforementioned contracts with telephone sets, facsimile machines, telephone switchboards, and the like.

Additionally, at corporations, commencement of use of telephone lines and connection of telephone sets have been additionally performed together with extension and expansion of business offices. Alternatively, suspension of telephone lines that are not in use, and conversely, reoperation of telephone lines that have been under suspension are frequently performed. Network facility administrators and persons responsible for general affairs of the relevant companies, for example, have been tasked with management of telephone lines and telephone sets for which operational statuses (whether or not the same is in use or under suspension) and connection statuses (locations of connection and line numbers, etc.) are changed from time to time.

Therefore, as noted, the operational statuses and connection statuses of telephone lines and telephone sets are changed from time to time. Thus, there exists a problem in that it is difficult for administrators to collectively manage the same. In particular, in relation to suspension and reoperation of lines, as an example, consider the existence of a subscribed line that is currently under suspension and previously had been used with the line number “03-xxxx-cccc” at a Tokyo business office. Next, such line is used after reoperation thereof with the line number “06-zzzz-dddd” at an Osaka business office. As described in this example, a change of line numbers may be involved. Thus, it is difficult to manage such change by tracking the same.

Additionally, in many cases, changes of use patterns of subscribed lines as described above take place at an on-site unit, such as a business office, but information to such effect is not shared with head offices. Thus, such situation makes it more difficult to manage the information on telephone sets and telephone lines.

Therefore, the applicant has disclosed technology regarding a device for managing the operational statuses of lines. That is to say, regardless of line number, such device grants to a subscribed line an external line ID that specifies the identify of a line whose operational status has been changed, and such device is used to manage whether the line to which such ID is linked is under suspension or is being operated. Thereby, even if the operational status has been changed, the identify of such line can be specified, and the change of various types of information related to a line accompanying the change of line numbers described above can be easily tracked and managed.

### CITATION LIST

Patent Reference 1: Unexamined Japanese Patent Application Publication No. 2011-050022

### SUMMARY OF THE INVENTION

### Problems to be Solved by the Invention

As an example, it is necessary for many corporations to connect a plurality of telephone sets. A communication system using so-called extension telephones as well as telephone sets connected to subscribed lines can be constructed. More specifically, the following communication system has been provided. That is, such system correlates subscribed lines as external lines with extension lines and manages the rank of internal lines using a private branch exchange. Phone calls between internal lines, phone calls from an internal line to an external line, or phone calls from an external line to an internal line can be made.

When the communication system has been constructed using extension telephones as described above and the operational statuses of subscribed lines as external lines are changed without permission, it will become impossible to make calls or accept incoming calls via such external lines from the extension telephones. As such, the operational statuses of such extension telephones would be changed. The prior art is problematic in that it can make it difficult to track and manage changes of the operational statuses of the aforementioned extension telephones as needed.

### Means for Solving the Problems

In order to solve the aforementioned problems, an extension telephone management system is provided. That is to say, such system grants IDs to external lines, and is used to manage whether such lines to which such IDs are linked are under suspension or are being operated. Thereby, even if operational statues have been changed, the identities of the relevant lines can be specified, and the changes of various forms of information related to lines accompanying the changes of line numbers described above can be easily tracked and managed. At the same time, telephone sets to which internal numbers are assigned also store the internal and external correspondence information that indicates what external line numbers can be reached by each telephone set to which an extension number is assigned. Thereby, the operational statuses of internal lines accompanying changes of the operational statuses of such external lines can be tracked and managed as needed.

In particular, one aspect of the present invention provides an extension telephone management system for managing the operating state of a plurality of extension lines, comprising an external line number input unit for inputting an external line number, an external line operating state input unit for inputting information on whether an external line is in a state of operation or a state of suspension, an external line operating state storage unit for storing external line IDs each correlated with an operating state of an external line, each such ID distinguishing the identity of such external line, and each such operating state having been changed via input of information into the external line operating state input unit, regardless of assigned external line number, an external line ID generation unit for generating the external line IDs as needed, an extension number input unit for inputting extension numbers, and an internal and external correspondence information storage unit for storing internal and external correspondence information that indicates what external line numbers can be reached by each telephone set to which an extension number is assigned.

Additionally, when the aforementioned configuration is provided, another aspect of the present invention provides the following: the aforementioned extension telephone management system, further comprising an extension telephone set class information storage unit for storing extension telephone set class information that indicates more than one of the following states: whether or not an external line can be used for any telephone calls, including international phone calls; whether or not an external line can only be used for domestic phone calls; whether or not an external line can only be used for short-distance domestic phone calls; whether or not an external line can only be used for local phone calls, and whether or not an external line can only be used for incoming phone calls, under the condition that each telephone set to which an extension number is assigned can used to reach any external line number.

Moreover, when the aforementioned configuration is provided, another aspect of the present invention provides the following: the aforementioned extension telephone management system, further comprising a user information storage unit for storing user information that identifies the user of an extension number; the extension telephone management system, comprising a user number information storage unit for storing user number information that indicates the number of users of extension numbers; the extension telephone management system, further comprising a location information storage unit for storing location information that indicates the location of a telephone set identified via an extension number; and the extension telephone management system, further comprising a group information storage unit for storing group information that indicates extension number grouping.

When the aforementioned configuration is provided, another aspect of the present invention provides the following: the aforementioned extension telephone management system, wherein the external line operating state storage unit includes means for storing history records for storing information from a time prior to a change of an external line number indicated via an external line ID, such means being available for use when a change occurs to the operating state of an external line number identified via a single external line ID due to the inputting of information into the external line operating state input unit.

Additionally, the present prevention also provides a method for operating an extension telephone management system as described above and a program for causing a computer to conduct the aforementioned operation.

Specifically, another aspect of the present invention provides the following: a method for operating an extension telephone management system for managing the operating state of a plurality of extension lines, comprising the steps of inputting an external line number; inputting information on whether an external line is in a state of operation or a state of suspension; keeping records for storing external line IDs each correlated with an operating state of an external line, each such ID distinguishing the identity of such external line, and each such operating state having been changed via input of information into the external line operating state input unit in the external line operating state storage unit, depending on the nature of each external line number; generating the external line IDs as needed; inputting extension numbers; and keeping records for storing internal and external correspondence information that indicates what external line numbers can be reached by each telephone set to which an extension number is assigned in the internal and external correspondence information storage unit.

Moreover, another aspect of the present invention provides the following: a program for causing a computer to manage the operating state of a plurality of extension lines, such program causing such computer to execute the steps of inputting an external line number; inputting information on whether an external line is in a state of operation or a state of suspension; keeping records for storing external line IDs each correlated with an operating state, each such ID distinguishing the identity of an external line, and each such operating state having been changed via input of information into the external line operating state input unit in the external line operating state storage unit, depending on the nature of each external line number; generating the external line IDs as needed; inputting extension numbers; and keeping records for storing internal and external correspondence information that indicates what external line numbers can be reached by each telephone set to which an extension number is assigned in the internal and external correspondence information storage unit.

### Effects of the Invention

In case that an extension telephone system has been constructed, even if the operational statuses of subscribed lines as external lines have been changed without permission as described above, the present invention, which has the configurations described above, will allow the tracking and management of changes to the operational statuses of extension telephones connected with such external lines as needed. Alternatively, the present invention will allow easy understanding of a situation in which, in regards to an internal number connected only with an extension line and not connected with an external line, even in cases in which a change of the operational status of an external line has taken place, it is possible not to monitor the extension line.

### BRIEF DESCRIPTION OF THE DRAWINGS

FIG. 1 is a diagram showing an example of a display screen for management based on information managed via an extension telephone management system of a first embodiment.

FIG. 2 is a diagram showing another example of a display screen for management based on information managed via the extension telephone management system of the first embodiment.

FIG. 3 is a diagram showing an example of a functional block diagram of the extension telephone management system of the first embodiment.

FIG. 4 is a conceptual diagram showing an example of a data table stored in the external line operating state storage unit of the extension telephone management system of the first embodiment.

FIG. 5 is a diagram showing an example of a GUI screen upon inputting of internal numbers via an extension number input unit of the extension telephone management system of the first embodiment.

FIG. 6 is a diagram showing an example of internal and external correspondence information stored in an internal and external correspondence information storage unit of the extension telephone management system of the first embodiment.

FIG. 7 is a diagram showing an example of a screen display using location information of the extension telephone management system of the first embodiment.

FIG. 8 is a diagram showing an example of the hardware configuration of the extension telephone management system of the first embodiment.

FIG. 9 is a flowchart showing an example of processes related to the extension telephone management system of the first embodiment.

### DETAILED DESCRIPTIONS OF PREFERRED EMBODIMENTS

Embodiments of the present invention will be described hereinafter with reference to the drawings. The present invention is not to be limited to the above embodiments and able to be embodied in various forms without departing from the scope thereof.

The first embodiment will mainly explain claims 1 through 9.

### First Embodiment

### Outline of First Embodiment

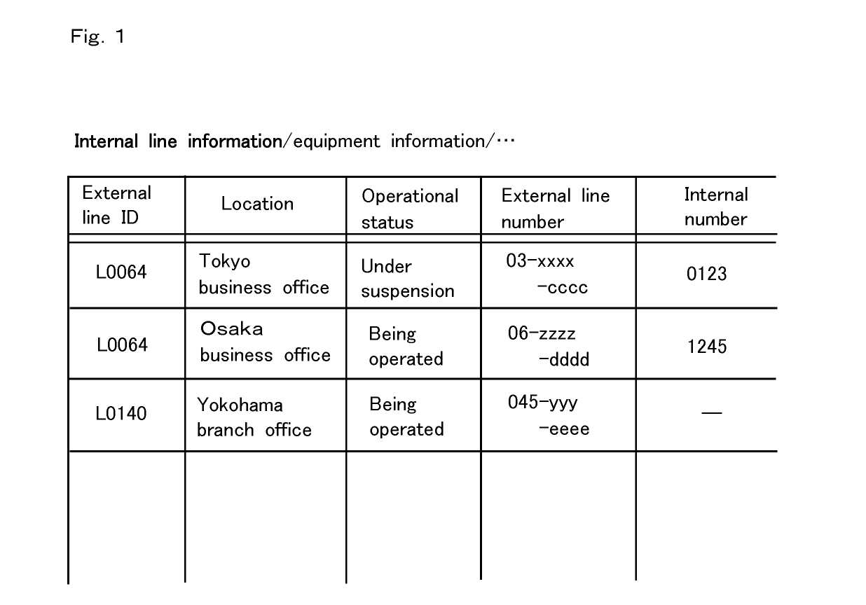

FIG. 1 is a diagram showing an example of a display screen for management based on the information managed via an extension telephone management system of a first embodiment. As described in FIG. 1, for example, when a user (e.g., a line subscriber, etc.) depresses a search key in an internal connection terminal, such as a key related to the name of a subscriber, the following information will be indicated. Such information includes the information about line numbers of telephone lines (external lines) to which the subscriber has subscribed, information as to the locations of telephone sets connected to such lines, etc., and the internal numbers of extension telephones for which such external line numbers can be used. Thus, specific information related thereto can be known. Moreover, in reference to the item “operational status,” it is possible to know whether a relevant external line is being operated (i.e., is available) or is under suspension. Therefore, for example, it can be revealed that it is possible to conduct phone calls among internal lines using the internal number “0123.” However, the external line number “03-xxxx-cccc” connected to such extension line is currently under suspension. Thus, connection to an external line would not be possible.

Moreover, in reference to external line IDs, for example, there may exist two records for external lines each identified by the external line ID “L0064,” as in FIG. 1. It is possible to obtain the following information: The operational status maintained in the record in which the location for one external line is a “Tokyo business office” and the external line number is “03-xxxx-cccc” is under suspension. Furthermore, the operational status maintained in the record in which the location for another external line is an “Osaka business office” and the external line number is “06-zzzz-dddd” is being operated (i.e., is available). The aforementioned information allows a user to easily understand the details of changes of relevant facts, such as the fact that both lines use the same subscriber line, the location of the telephone set for each line has been changed, and the line numbers have been changed. Additionally, the external line number “06-zzzz-dddd” of the Osaka business office is correlated with the internal number “1245.” This information reveals that outgoing and incoming calls are can both be made from such number. Moreover, it is acceptable to configure the aforementioned records such that the records are correlated with dates on which information not illustrated in FIG. 1, etc. was imputed, and the resultant is stored. Furthermore, clicking an internal number using a mouse cursor within the aforementioned display screen allows calls to be made to such internal number.

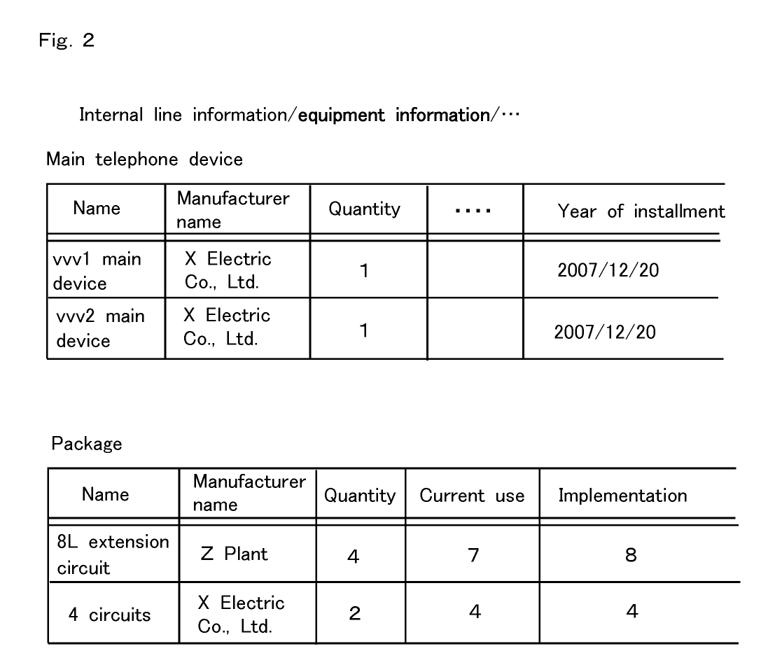

When “equipment information” on the upper part of the screen as shown in FIG. 1 is clicked, for example, information on equipment related to the relevant telephone sets shown in FIG. 2 is displayed. For example, it becomes possible to confirm information such as the location of the telephone exchange (main telephone device) for telephone lines, the number of free ports thereof, and the like. Moreover, in reference to the aforementioned information, for example, it is easy to learn whether or not telephone sets can be added to free ports even when neither line suspension takes place nor a subscription contract for a new line is made.

### Functional Configuration of First Embodiment

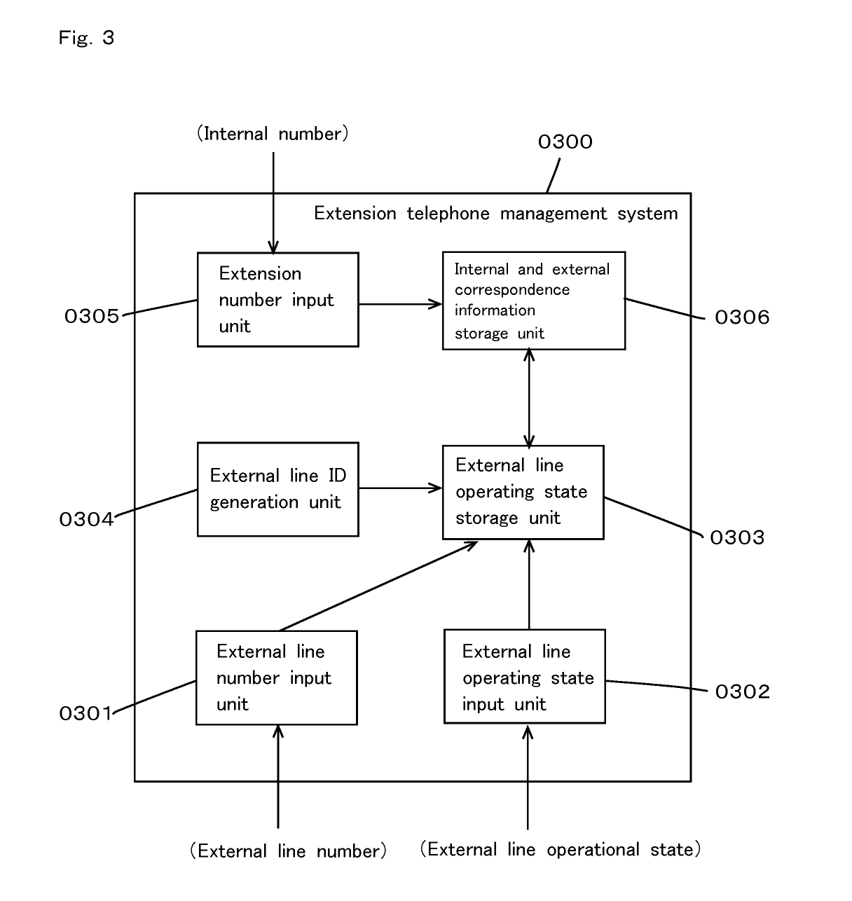

FIG. 3 is a diagram showing an example of a functional block diagram of the extension telephone management system of the first embodiment. Constituent features of the extension telephone management system described below can be constructed using hardware, software, or both hardware and software. Specifically, in the case of using a computer, the respective units are implemented by the hardware configured by a CPU, a main memory, a bus, a secondary storage device (e.g., a hard disk or a nonvolatile memory, a storage media such as CD or DVD, or a reading drive for the above media), printing device, display device, other peripheral devices, and the like, and I/O port for such other peripheral devices, other application programs and driver program for controlling the above hardware, a user interface for inputting information, and the like.

Subsequently, the CPU executes operation in accordance with the program loaded into the main memory, so that processing and storing of the data, inputted through the interface etc. and stored in the memory or the hard disk, are carried out, and instructions to control the hardware and software are generated. Moreover, the present invention can be implemented not only as a system but also as a method thereof. Moreover, a portion of such invention may be configured as software. Furthermore, a software product used for causing a computer to execute the software, and the recording medium, in which the such product is installed, should be included in the technical scope of the present invention (the same applies throughout the entire specification).

As shown in FIG. 3, an extension telephone management system 0300, which is a system for managing the operational statuses of a plurality of internal lines, comprises an external line number input unit 0301, an external line operating state input unit 0302, an external line operating state storage unit 0303, an external line ID generation unit 0304, an extension number input unit 0305, and an internal and external correspondence information storage unit 0306.

The external line number input unit 0301 has the function of inputting external line numbers. For example, such unit can be constructed using various input devices and GUIs (graphical user interface), or communication mechanisms that acquire external line numbers via communication by external devices. Additionally, the term “external line number” refers to a number that specifies a telephone set that is the destination for a telephone connection, is particularly assigned to a subscribed line, and allows external phone calls via the PSTN. An example of such a number is “03-1234-5678.” However, as described above, even regarding the same subscribed line, in case that the location of a telephone set, etc. is changed from Tokyo to Osaka, for example, such change will be accompanied by a change of the relevant external line number. Therefore, it is difficult to know about the type of a subscribed line or a change of location as described above, etc. based on the external line number mentioned above. Thus, the first embodiment is configured so that an external line ID is automatically generated by an external line ID generation unit described below, and thereby, the identify of line can be determined regardless of the assigned external line number.

In addition, examples of devices at destinations specified by external line numbers include fax machines, telephone exchanges, or IP (Internet Protocol) phones, etc., in addition to telephone sets.

The external line operating state input unit 0302 has the function of inputting whether or not an external line is being operated or is under suspension. For example, such unit can be constructed using various input devices and GUIs, or communication mechanisms which acquire external line numbers via communication by external devices. In addition, the expression “an external line is being operated” refers to a situation in which a telephone set has been connected to the relevant external line and telephone connection is possible. The expression “an external line is under suspension” refers to a situation in which a telephone set has not been connected to the relevant external line and telephone connection is not possible.

Additionally, a state in which there already exists no external line may be included among the examples of operational statuses of external line numbers (e.g., following termination of a subscription contract for a line). By inputting and storing operational statuses, including the status of “a contract having been terminated,” it is possible to manage all histories of contracts effective up to the present.

Such information about operational statuses of external lines is inputted by an operator via an input device into the corresponding item indicated on a display, for example.

The external line operating state storage unit 0303 has the function of correlating external line IDs with operational statuses and storing the resulting information. For example, such unit can be constructed using various recording devices, such as an HDD, flash memory, optical recording media, a driving device thereof, etc. The term “external line ID” refers to an ID used in order to specify the identity of a line whose operational status has been changed via input into the external line operating state input unit, regardless of assigned external line number.

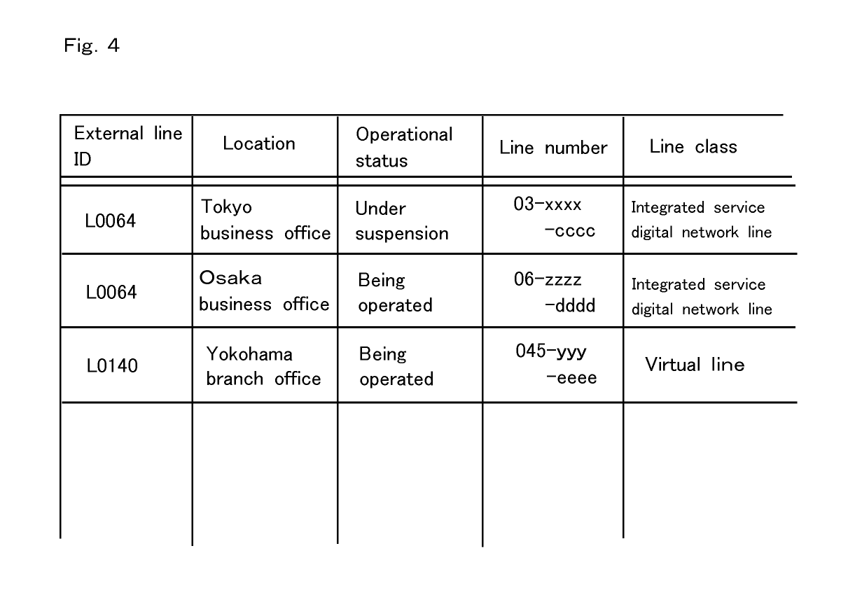

FIG. 4 is a conceptual diagram showing an example of a data table stored in the external line operating state storage unit of the extension telephone management system of the first embodiment. As described in FIG. 4, for example, there may exist two records for the external line ID “L0064.” It can be indicated that the operational status for the external line number “03-xxxx-cccc” for one record is under suspension while the operational status for the external line number “06-zzzz-dddd” for another record is being operated. In reference to the aforementioned information, even if one external line number differs from another, it becomes easily possible to know that both numbers use the same subscriber line. Additionally, it may be possible to correlate the line class (e.g., exclusive line, advanced information communication line, and the like), the purpose of use of an external line number (e.g., use for Internet or for support), the name of a contracting phone company, and an incoming line ID in the aforementioned data table, and to store the resultant. The aforementioned information, in addition to that regarding operational status, is correlated with an external line ID, and the resultant is stored in the data table. Thereby, a user can further know details about the situation of such line.

Additionally, it is acceptable to include information about the location of a telephone set connected to a certain external line number in such data table, and details regarding the same are given below. Moreover, it is acceptable to store the information on a main telephone device, etc. For example, the a main telephone device may contain information about the connectable port number and the number of ports currently available in relation to such main telephone device. Using such information, it is also possible to easily know whether or not telephone sets can be added to the main telephone device.

When information about operational statuses indicating that subscribed lines would cease to exist, such as information about “line contract termination,” etc., is inputted via the external line operating state input unit, such external line operating state storage unit may be configured to delete and not to manage the relevant external line ID thereafter, or such external line ID may be configured to be reused via the external line ID generation unit stated below. Alternatively, without deleting the aforementioned external line ID, the relevant record may be configured to be closed (i.e., so that renewal of items would not be possible), to be continuously managed thereafter, and to be able to confirm histories, including contract termination.

As described above, in reference to an external line ID, even if an external line number has been changed due to movement of the location of telephone set facilities, etc., the identities of lines can be specified, and management of lines themselves can be performed. Additionally, in reference to other items of relevant records, it is possible to know line class, purpose of use, location of connected telephone sets, and the like.

The external line ID generation unit (0304) has the function of generating the aforementioned external line IDs as needed. For example, such unit can be constructed using a CPU, a main memory, or an external line ID generation program. Specifically, for example, the following method can be used. In regards to generation of the external line IDs, in case that new external line numbers are to be established and additional external line numbers will be made, new external line IDs is configured so as to be assigned to such external line numbers. Alternatively, upon change, older external line IDs may be used, and new IDs will not be assigned. Additionally, when the assignment mentioned above takes place, a method for generating and assigning external line IDs in a random manner can be used so that such IDs would not overlap, using a table of random numbers, etc. Furthermore, a method for assigning external line IDs sequentially from 000001 can be used, so that such numbers would not be overlap.

The generation of external line IDs as mentioned above allows specification of the identities of relevant lines, regardless of assigned external line number. In reference to external line IDs, it becomes possible to easily know the usage history, the previous usage situation, and the current usage situation of the relevant lines.

The extension number input unit 0305 has the function of inputting internal numbers. For example, such unit can be constructed using various input devices and GUIs (graphical user interface), or communication mechanisms which acquire external line numbers via communication by external devices. Additionally, the term “internal numbers” refers to numbers that specify a telephone set of destination via telephone connection and allow internal phone calls to be made using an exclusive line or private branch exchange without using the PSTN. An example includes the number “0123,” etc.

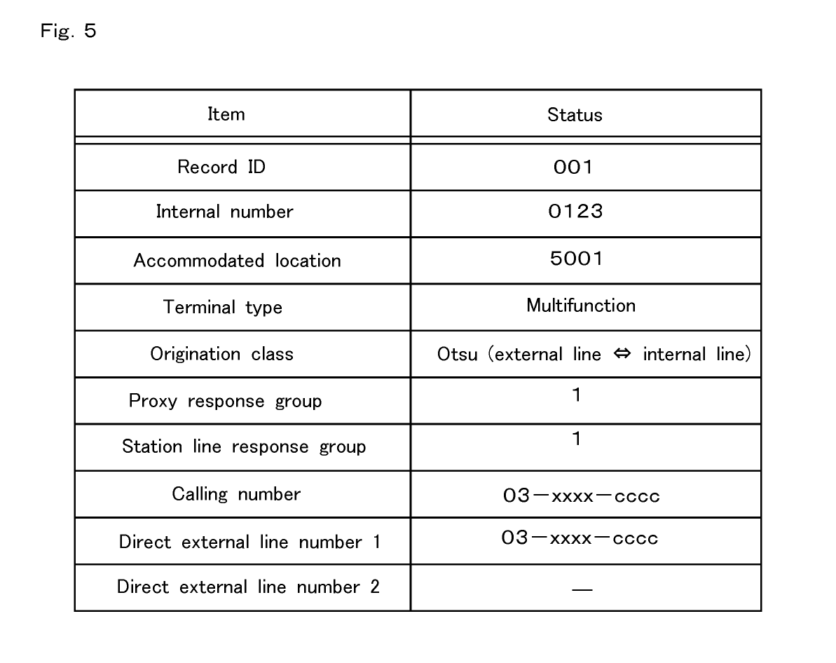

FIG. 5 is a diagram showing an example of a GUI screen upon inputting internal numbers. As illustrated in FIG. 5, for example, “0123” as an internal number used for an extension telephone is used through keyboard operation. Moreover, on the GUI screen, in regards to an extension telephone that can be identified by the internal number “0123,” in addition to such number, an accommodated location, a terminal type, an ID of a proxy response group, an ID of a station line response group, a calling number and direct external line number (in the case of an external connection), etc. may be also inputted. Moreover, in addition to inputting via the aforementioned GUI, configuration may be realized by converting the setting information of a private branch exchange as mentioned above into a predetermined format and automatically including such information, and thereby, inputting internal numbers and other information.

It is possible to connect an extension telephone having the aforementioned internal number “0123” with a telephone set identified by the external line number “03-xxxx-cccc” as illustrated in FIG. 5. However, as described above, the operational status of the subscribed line identified by such external line number may be changed from time to time. Moreover, for example, by changing the location of a telephone set from Tokyo to Osaka, even in a case involving the same subscribed line, change of the external line number thereof may take place in some cases.

Therefore, according to the extension telephone management system of the first embodiment, as explained below, the internal and external correspondence information indicating what external line number can be used by a telephone set to which internal numbers have been assigned is stored. Thereby, it is possible to easily understand whether or not the operational statuses of internal lines have changed based on the change of the operational statuses of external lines.

The internal and external correspondence information storage unit 0306 has the function of storing the internal and external correspondence information. For example, such unit can be constructed using various recording devices, such as an HDD, flash memory, optical recording media, and driving device thereof, etc. The term “internal and external correspondence information” refers to information indicating what external line number can be used by a telephone set to which internal numbers have been assigned. For example, table data can be used. That is, in case that it is possible to use external line numbers via internal numbers, such internal numbers are correlated with such available external line numbers and external line IDs related to such external line numbers. If such external line numbers cannot be used due to restrictions implemented by setup (e.g., setup for a class for which phone calls are possible for internal lines), table data correlated with a flag indicating the same can be used.

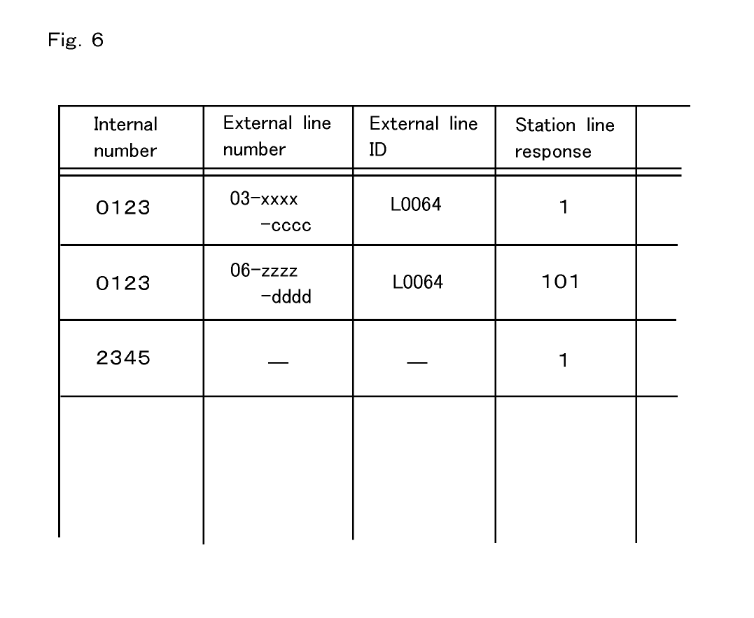

FIG. 6 is a diagram showing an example of the internal and external correspondence information stored in the aforementioned internal and external correspondence information storage unit. As shown in FIG. 6, for example, the internal number “0123” can be connected to an external line and is correlated with the external line number “03-xxxx-cccc,” which is matched with the external line ID “L0064.” On the other hand, the internal number “2345” is not connected to an external line but to an internal line only, and thus, such number is not correlated with an external line number or an external line ID.

In reference to the internal and external correspondence information stored in the internal and external correspondence information storage unit and data stored in the external line operating state storage unit based on the external line numbers and external line IDs correlated therewith, in regards to internal numbers, it is possible to easily understand whether or not an external connection is possible based on changes in the operational statuses of external line numbers, or whether or not internal numbers can be used independently of changes of operational statuses of external lines, because such lines were not connected to external lines originally, etc.

Additionally, the extension telephone management system of the first embodiment may have various further constituent features that can be constructed using recording media, such as an HDD or flash memory. The same example applies to an extension telephone set class information storage unit, a location information storage unit, a line class information storage unit, a use purpose information storage unit, an equipment information storage unit, and a means for storing history information, etc.

The extension telephone set class information storage unit comprises the function of storing extension telephone set class information that indicates more than one of the following states: whether or not an external line can be used for any telephone calls, including international phone calls; whether or not an external line can only be used for domestic phone calls; whether or not an external line can only be used for short-distance domestic phone calls; whether or not an external line can only be used for local phone calls, and whether or not an external line can only be used for incoming phone calls, under the condition that each telephone set to which an extension number is assigned can used to reach any external line number.

The user information storage unit further has the function of storing user information indicating the user of an internal number. The user number information storage unit further has the function of storing user number information for internal numbers. Moreover, the group information storage unit further has the function of storing group information indicating grouping of internal numbers.

Using the information stored in the extension telephone set class information storage unit, the user number information storage unit, the user information storage unit, and the group information storage unit, it is preferable to present to a user data indicating the callable scope of an extension telephone and data indicating grouping, such as that related to users of extension telephones, the number of such users, and representative outgoing calls of internal numbers, etc.

The location information storage unit has the function of storing location information indicating the location of terminal equipment shown by internal numbers. As mentioned above, it is easy to understand the location in which an extension telephone that is being operated is located, etc.

Additionally, using the location information stored in the location information storage unit, it is acceptable for the extension telephone management system of the first embodiment to display information as described below and to provide users with relevant information.

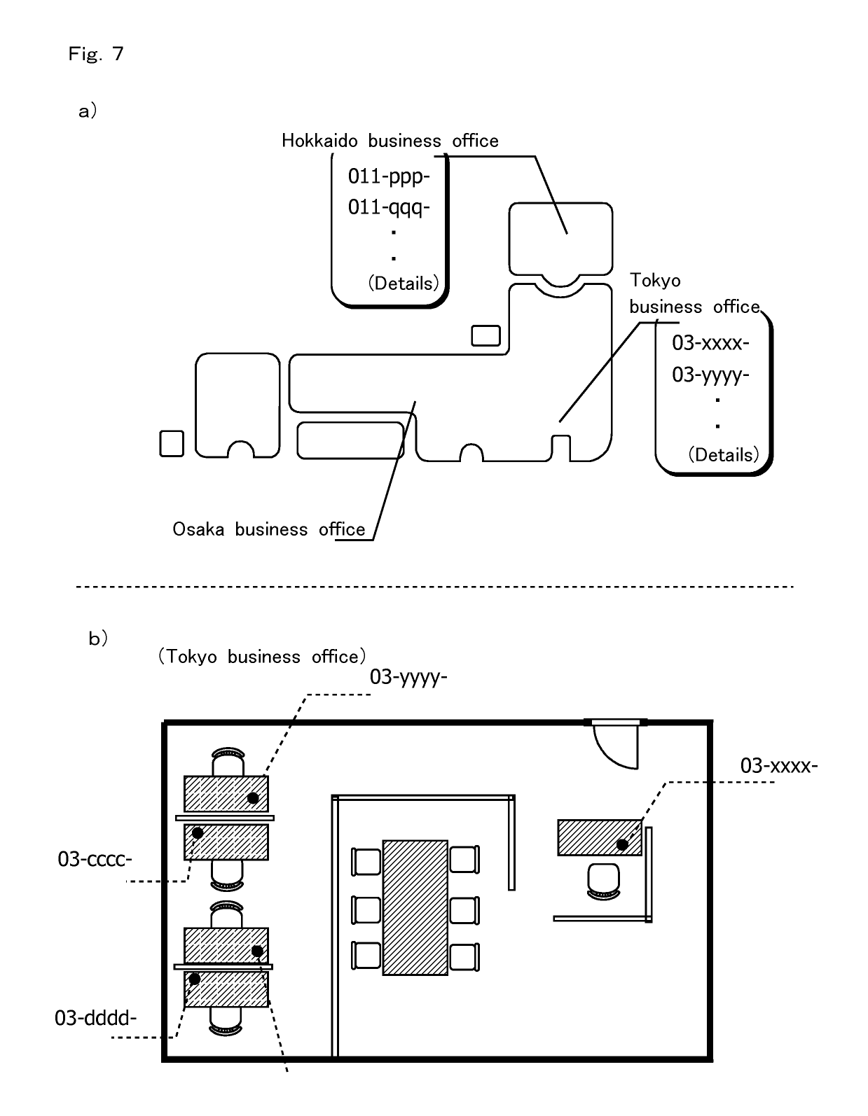

FIG. 7 is a diagram showing an example of screen display using the location information of the extension telephone management system of the first embodiment. As shown in FIG. (a), for example, a map of Japan and a regional map are displayed on a screen. Using the aforementioned location information, internal numbers that are superimposed upon locations of telephone sets on the map are displayed. As such, it is easy for a user to visually ascertain at what location relevant lines are being used.

As described in FIG. 7(b), in lieu of maps, configuration may be realized by displaying a layout for a business office, etc., and in the same manner, in reference to location information, displaying internal numbers on such layout. Additionally, configuration may be realized by displaying locations of modular jacks for telephone lines in such layout in conjunction with the aforementioned information. Moreover, as stated below, in reference to the stored sending and receiving histories for each line, configuration may be realized by distinctively indicating displays of internal numbers in the aforementioned layout (e.g., highlighting internal numbers that are used frequently) based on usage history.

The means for storing history records has the function of storing information from a time prior to a change of an external line number indicated via an external line ID, such means being available for use when a change occurs to the operating state of an external line number identified via a single external line ID due to the inputting of information into the external line operating state input unit. For example, in regards to an external line ID that “is under suspension,” in case that information about the operational status of “being operated” is inputted, a record related to the external line ID that is under suspension stored within the database remains. While such record remains, a record indicating “being operated” for the same external line ID is newly added, and the resultant is recorded. Thus, it is preferable in that it allows the user to know the most recent status through addition of information about the dates of updating.

Moreover, the extension telephone management system of the first embodiment may have the following function. For example, it may be configured to obtain information (e.g., sending and receiving dates for lines, the frequency of sending and receiving, identification information for the part(ies) involved in sending and receiving, etc.) indicating the usage situation of each line, such as by installing predetermined devices in telephone sets that are being operated, etc. And such obtained information is recorded in the corresponding records within the data table shown in FIG. 4 mentioned above.

When instructions for confirmation of line usage situations are received from a user via a GUI, a screen on which aligned external line numbers, external line IDs, and internal numbers are listed is displayed and a screen on which external line numbers are distributed to the map and business office layout shown in FIG. 7 is displayed. For example, in reference to the information indicating the usage situation of each line for the most recent month, color-coded external line numbers, external line IDs, and internal numbers on the screen are displayed based on the line usage frequency. Alternatively, using information about sending and receiving dates, in order to reproduce the usage situation for the most recent month based on a 1-minitue timeline, external line numbers, external line IDs, and internal numbers on the screen that are being used during the reproduction of usage situation are displayed by blinking or by a graph.

As such, it is easy for a user to know on what lines usage is concentrated, how usage of lines is concentrated, or how usage of lines is dispersed with the elapse of time. Based on such knowledge, it can be determined whether or not additional subscription to new lines should take place, whether or not internal lines should be added, and whether or not certain lines can be suspended, etc. Alternatively, configuration may be realized by extracting unused lines and identifying the same as candidate lines for which subscription contracts might not be necessary.

<Hardware Configuration>

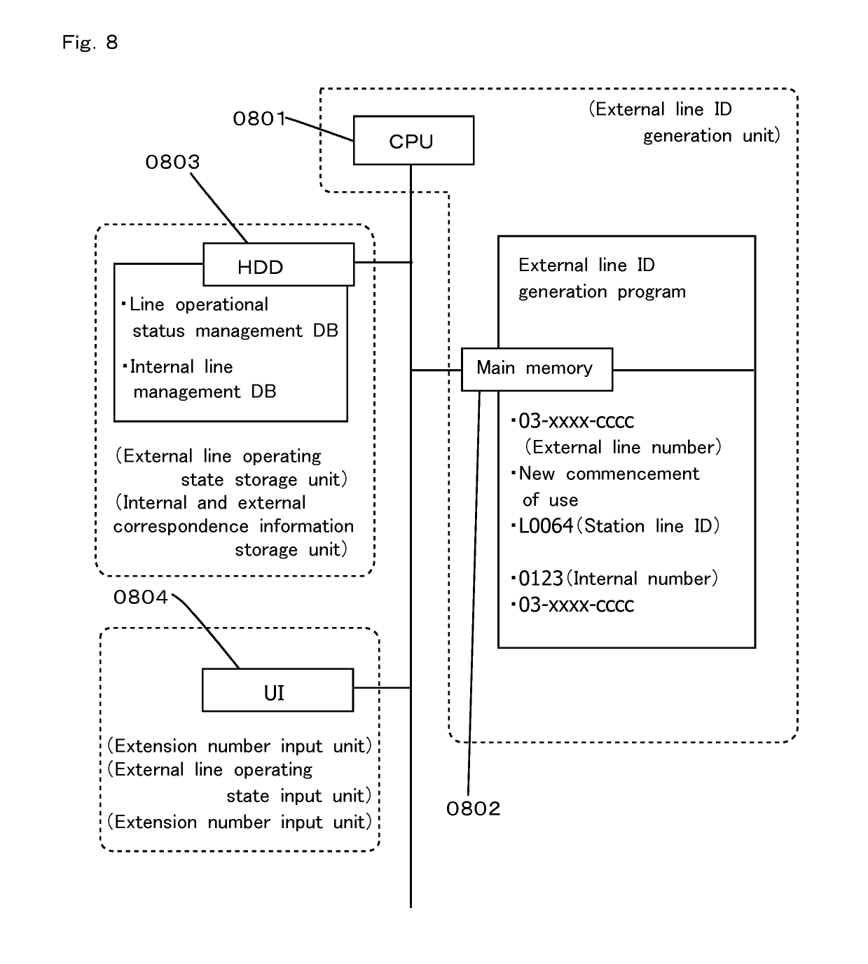

FIG. 8 is a diagram showing an example of configuration of the hardware configuration of extension telephone management system. The operation of the hardware components in relation to management and processing of the operational statuses of internal lines will be described with reference to FIG. 8.

As described in FIG. 8, the extension telephone management system comprises a CPU 0801 and a main memory 0802, which make up the external line ID generation unit. It is preferable to have an external line operating state storage unit, an HDD 0803, which is internal and external correspondence information storage unit, an external line number input unit, an extension number input unit, a UI (User Interface) 0804, which is an external line operating state input unit, etc. The aforementioned components are mutually connected via a data communication path, such as a system bus, etc., and transmit, receive, and process information.

Additionally, programs are loaded into the main memory, the CPU refers to such loaded program, and executes various operations in accordance with procedures indicated by the program. Moreover, a plurality of addresses are assigned to the main memory and the HDD, and in the calculation by the CPU, address specification and access to the stored data are carried out, thereby executing the calculation by utilizing the data.

For example, it may have been determined that telephone sets would be newly set up at a certain business office, and that lines would become operational through a contract with a phone company. When external line numbers, etc. have been actually assigned to the telephone sets within the business office, information indicating that external line numbers and lines of such telephone sets have been newly set up via a UI is inputted. Such information is stored in the addresses 1 and 2 of the main memory. In such a case, the CPU interprets the external line ID generation program and the following processes are executed based on results of such interpretation.

First of all, it is confirmed whether or not the information stored in the address 2 is information indicating that lines have been added due to new commencement of use of lines. In case that such information is information to such effect, in reference to the line operational status management database stored in the HDD, IDs that do not overlap the currently used external line IDs are generated in accordance with the predetermined generation rule, such as adding numbers to IDs in “+1” increments. The generated external line IDs are stored in the address 3 of the main memory.

The external line numbers stored in the address 1 of the main memory are correlated with the external line IDs stored in the address 3, the operational statuses thereof are established as being operated, and a new record is added to the external line operational status management database stored in the HDD.

Thereafter, in case that such telephone sets have not been used, if the telephone sets are removed, information indicating that the relevant external line numbers and operational statuses are “under suspension” via the UI is inputted, and such information is stored in the addresses 1 and 2 of the main memory. Retrieval processing of the external line operational status management database using an external line number as a key based on logic operation processing of the CPU is executed, and the corresponding record and external line ID are specified. The operational status associated with such external line ID is changed into the status “under suspension” and the relevant record is renewed. Thereupon, it is preferable that configuration may be realized by judging what record is the newest by inputting dates for update in conjunction.

Thereafter, in case that it is necessary to newly establish telephone sets, requests for searching for lines whose current operational statuses are under suspension are inputted via the UI. When this takes place, the external line operational status management database is searched through logic operation processing of the CPU, and record information describing that the newest operational status is “under suspension” is extracted. In case that lines for new establishment of phones from among the extracted subscribed lines have been specified, if new external line numbers have been established in accordance with a renewal contract with a phone company, information indicating such new external line numbers and external line IDs thereof is inputted via the UI. If this takes place, record information in which such external line IDs and external line numbers are associated with each other and in which the relevant operational status is indicated as “being operated” is added as new record information to the external line operational status management database of the “HDD.”

As described above, it is possible to maintain records that allow specification of the identities of external lines within the external line operational status management database, using an external line ID as a key, regardless of assigned external line number.

Furthermore, for example, using a private branch exchange, in case that a communication system is established using extension telephones, in regards to the adopted extension telephones, internal numbers of such extension telephones, external line numbers of lines that are connectable to such extension telephones, or if such extension telephones cannot be connected to external lines, information to such effect are inputted via the UI.

A new record with which the aforementioned inputted information is associated is added to the internal line management database information accumulated in the HDD. In reference to the internal line management database and the external line operational status management database, for example, upon change of operational statuses of external line numbers as mentioned above, information to the effect that it has become impossible for the corresponding internal lines to be connected to external lines by presenting to a user internal numbers stored in the HDD in association with the aforementioned change is reported. And information to the effect that internal lines are available independently of the changes of operational statuses of external lines is reported to a user.

### Processing Flow of First Embodiment

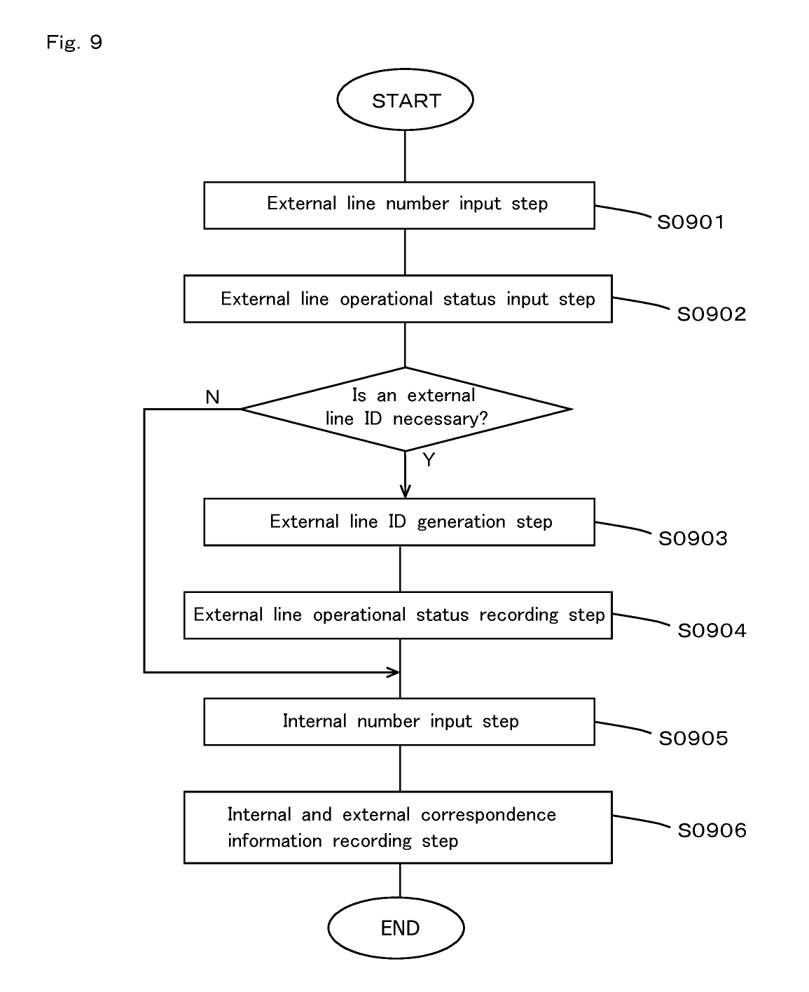

FIG. 9 is a flowchart showing an example of processes of the extension telephone management system of the first embodiment. Note that, the following steps may configure a program, which is stored in a medium and is for controlling the computer.

As shown in FIG. 9, external line numbers are inputted via the UI, etc. (external line number input step: S0901), and information as to whether such lines are being operated or are under suspension is inputted (external line operational status input step: S0902). Regardless of assigned external line numbers, external line IDs for specifying the identities of the lines whose operational statuses have been changed through inputting information into the external line operating state input unit are generated as needed (external line ID generation step: S0903). In association with such generated external line IDs and operational statuses, relevant information is recorded and maintained in the database (external line operational status recording step: S0904).

Upon adoption of internal lines, internal numbers of the adopted extension telephones are inputted (internal number input step: S0905). Furthermore, internal and external correspondence information that indicates what external line numbers can be reached by each telephone set to which an extension number is assigned is recorded for storing such information in the database (internal and external correspondence information recording step: S0906).

### Brief Description of Effects of First Embodiment

As explained above, the extension telephone management system of the first embodiment allows easy understanding of whether or not internal numbers cannot be externally connectable based on changes of operational statuses of external line numbers and whether or not internal numbers can be used independently of changes of operational statuses of external lines because such lines have not been connected to external lines originally, etc.

### DESCRIPTION OF REFERENCE NUMERALS

0300 Extension telephone management system

0301 External line number input unit

0302 External line operating state input unit

0303 External line operating state storage unit

0304 External line ID generation unit

0305 Extension number input unit

0306 Internal and external correspondence information storage unit

1. An extension telephone management system for managing the operating state of a plurality of extension lines, comprising:
an external line number input unit for inputting an external line number;
an external line operating state input unit for inputting information on whether an external line is in a state of operation or a state of suspension;
an external line operating state storage unit for storing external line IDs each correlated with an operating state of an external line, each such ID distinguishing the identity of such external line, and each such operating state having been changed via input of information into the external line operating state input unit, regardless of assigned external line number;
an external line ID generation unit for generating the external line IDs as needed;
an extension number input unit for inputting extension numbers; and
an internal and external correspondence information storage unit for storing internal and external correspondence information that indicates what external line numbers can be reached by each telephone set to which an extension number is assigned.

2. The extension telephone management system according to claim 1, further comprising an extension telephone set class information storage unit for storing extension telephone set class information that indicates more than one of the following states:
whether or not an external line can be used for any telephone calls, including international phone calls; whether or not an external line can only be used for domestic phone calls; whether or not an external line can only be used for short-distance domestic phone calls; whether or not an external line can only be used for local phone calls, and whether or not an external line can only be used for incoming phone calls, under the condition that each telephone set to which an extension number is assigned can used to reach any external line number.

3. The extension telephone management system according to claim 1, further comprising a user information storage unit for storing user information that identifies the user of an extension number.

4. The extension telephone management system according to claim 1, comprising a user number information storage unit for storing user number information that indicates the number of users of extension numbers.

5. The extension telephone management system according to claim 1, further comprising a location information storage unit for storing location information that indicates the location of a telephone set identified via an extension number.

6. The extension telephone management system according to claim 1, further comprising a group information storage unit for storing group information that indicates extension number grouping.

7. The extension telephone management system according to claim 1, wherein the external line operating state storage unit includes means for storing history records for storing information from a time prior to a change of an external line number indicated via an external line ID, such means being available for use when a change occurs to the operating state of an external line number identified via a single external line ID due to the inputting of information into the external line operating state input unit.

8. A method for operating an extension telephone management system for managing the operating state of a plurality of extension lines, comprising the steps of:
inputting an external line number;
inputting information on whether an external line is in a state of operation or a state of suspension;
keeping records for storing external line IDs each correlated with an operating state of an external line, each such ID distinguishing the identity of such external line, and each such operating state having been changed via input of information into the external line operating state input unit in the external line operating state storage unit, depending on the nature of each external line number;
generating the external line IDs as needed;
inputting extension numbers; and
keeping records for storing internal and external correspondence information that indicates what external line numbers can be reached by each telephone set to which an extension number is assigned in the internal and external correspondence information storage unit.

9. A program for causing a computer to manage the operating state of a plurality of extension lines, such program causing such computer to execute the steps of:
inputting an external line number;
inputting information on whether an external line is in a state of operation or a state of suspension;
keeping records for storing external line IDs each correlated with an operating state, each such ID distinguishing the identity of an external line, and each such operating state having been changed via input of information into the external line operating state input unit in the external line operating state storage unit, depending on the nature of each external line number;
generating the external line IDs as needed;
inputting extension numbers; and
keeping records for storing internal and external correspondence information that indicates what external line numbers can be reached by each telephone set to which an extension number is assigned in the internal and external correspondence information storage unit.
